(19) United States
(12) Patent Application Publication
(10) Pub. No.: US 2006/0150794 A1
(43) Pub. Date: Jul. 13, 2006

(54) Apparatus for and method of cutting spacing adhesive tape

(76) Inventors: Jong-Hoon Kim, Daejeon Metropolitan City (KR); Hyun-Suk Kwak, Seoul (KR); Tae-Hyun Kim, Chungcheongnam-do (KR); Jong-Soo Jeong, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/329,914

(22) Filed: Jan. 10, 2006

(30) Foreign Application Priority Data
Jan. 11, 2005 (KR) 2005-02461

(51) Int. Cl. B26D 5/08

(52) U.S. Cl. 83/614

(57) ABSTRACT

In an embodiment, an apparatus is configured to cut a tape, such as a spacing adhesive tape. The apparatus is easy to maintain and blade life is extended, and the quality of the cuts are superior. In an embodiment the method includes preparing a spacing adhesive tape used in a semiconductor manufacturing process, fixing the spacing adhesive tape to a worktable, and cutting the spacing adhesive tape using a pair of wheel-shaped blades.

### BACKGROUND OF THE INVENTION

This application claims the priority of Korean Patent Application No. 10-2005-0002461, filed on Jan. 11, 2005, in the Korean Intellectual Property Office, the disclosure of which is incorporated herein in its entirety by reference.

1. Field of the Invention

The present invention relates to an apparatus for, and a method of, cutting a tape used in a semiconductor package, and more particularly, to an apparatus for and a method of, cutting a spacing adhesive tape used in a quarter die package.

2. Description of the Related Art

A die attaching process involves assembling a semiconductor package, and attaching individual semiconductor chips that have been separated from a wafer to a leadframe or a substrate in a printed circuit board (PCB) form. Generally, the die attaching process varies according to the type of semiconductor package. For example, in the case of a multi-chip package, adhesive tape functioning as a spacer is mounted on a semiconductor chip attached to a leadframe to attach another semiconductor chip directly on the semiconductor chip. This process is called a spacing adhesive tape mounting process.

Referring to FIG. 1, in a quarter die package (QDP), a pair of semiconductor chips 38A and 38B are on a top surface of a chip pad 32 of a leadframe 36, using spacing adhesive tape 42A. In addition, another pair of semiconductor chips 38C and 38D are on a bottom surface of the chip pad 32, using the spacing adhesive tape, 42B. The semiconductor chips 38A through 38D are connected to a lead 34 of the leadframe 36 by a gold wire 40. An epoxy mold compound 44 seals a portion of the gold wire 40, the semiconductor chips, and the leadframe 38, protecting them from external impacts.

The semiconductor chips 38A and 38C are adhered to the chip pad 32 by film-type adhesive tape 46 respectively attached to bottom surfaces of the semiconductor chips 38A and 38C. In addition, the semiconductor chips 38B and 38D are respectively adhered to the semiconductor chips 38A and 38C by the film-type adhesive tape 46 respectively attached to bottom surfaces of the semiconductor chips 38B and 38D.

The spacing adhesive tape 42A and 42B is interposed between the semiconductor chips 38A and 38B, and between the semiconductor chips 38C and 38D, respectively. Hence, the spacing adhesive tape 42A, 42B protects circuit areas of the semiconductor chips 38A and 38C and provides wire-bonding space for the semiconductor chips 38A and 38C.

Referring to FIGS. 2 and 3, generally, the spacing adhesive tape 42 is wound around a reel 26. The spacing adhesive tape 42 includes a polyimide film 22 as a basic material, or substrate, and adhesive layers 24 respectively formed on top and bottom surfaces of the polyimide film 22. When the spacing adhesive tape 42 is exposed to a smooth surface at room temperature for more than 10-15 minutes, the spacing adhesive tape 42 is adhered to the smooth surface by the adhesive layers 24. Since the spacing adhesive tape 42 is formed of polyimide, it is flexible. However, since the spacing adhesive tape 42 has a strong tensile force and rupture strength, when the spacing adhesive tape 42 is cut more than, say, 2000 times using an ultra-hard blade, even the ultra-hard blade becomes dulled and abraded.

FIGS. 4A and 4B are perspective views of a blade 20A and 20B, respectively, used to cut the spacing adhesive tape 42. Specifically, FIG. 4A shows the blade 20A before being used, and FIG. 4B shows the blade 20B after being used. The blade 20A is fixed to an apparatus for cutting spacing adhesive tape. The blade 20A or 20B cuts the spacing adhesive tape 42 by horizontally sliding within the apparatus, so a specific portion 21 of the blade 20B may be unevenly abraded. Consequently, the blade 20B lasts only for about 2000 cuts of the spacing adhesive tape 42.

In addition, if dust on the adhesive layers 23 of the spacing adhesive tape 42 is adhered to the blade 20B and solidified, the spacing adhesive tape 42 is not cut uniformly. The spacing adhesive tape 42 may not be cut straight or may be cut diagonally. Therefore, in the spacing adhesive tape mounting process, blades must be frequently replaced, thus requiring a lot of time for maintenance and undermining the operating rate of the cutting apparatus.

FIG. 5 is a sectional view of the QDP with a defect caused by poor cutting of the spacing adhesive tape 42. Since the spacing adhesive tape 42 was not cut in a uniform size, space for wire bonding was not secured in the semiconductor chips 38A and 38C. As a result, the QDP became defective. Referring to FIG. 5, the spacing adhesive tape 42A mounted on the semiconductor chip 38A attached to the top surface of the chip pad 32 was not cut straight. Thus, the length of the cut spacing adhesive tape 42A was extended. The spacing adhesive tape 42B under the chip pad 32 was cut diagonally.

In a multi-chip package like the QDP, the technology for cutting spacing adhesive tape uniformly is a key determiner of the defect rate of the QDP. The spacing adhesive tape 42A and 42B fixes the semiconductor chips 38B and 38D and, at the same time, provides space for wire-bonding the semiconductor chips 38A and 38C. Therefore, problems of the spacing adhesive tape 42 being pushed back and forth, not being cut straight, or having to be frequently replaced must be tackled to lower the defect rate and improve productivity.

### SUMMARY OF THE INVENTION

The present invention provides an apparatus for cutting spacing adhesive tape. The apparatus is easy to maintain, extends the lifespan of a blade, and cuts the spacing adhesive tape in a uniform size.

The present invention also provides a method of cutting spacing adhesive tape, to easily maintain and extend the lifespan of a blade, and to cut the spacing adhesive tape in a uniform size.

### BRIEF DESCRIPTION OF THE DRAWINGS

The above and other features and advantages of the present invention will become more apparent by describing in detail exemplary embodiments with reference to the attached drawings in which:

FIG. 1 is a sectional view of a quarter die package (QDP) using a spacing adhesive tape;

FIG. 2 is a perspective view of the spacing adhesive tape wound around a reel;

FIG. 3 is a sectional view of the spacing adhesive tape;

FIGS. 4A and 4B are perspective views of a blade used to cut the spacing adhesive tape;

FIG. 5 is a sectional view of the QDP with a defect caused by poor cutting of the spacing adhesive tape;

FIG. 6 is a lateral view of a pair of wheel-shaped blades for illustrating a method of cutting spacing adhesive tape according to an embodiment of the present invention;

FIG. 7 is a perspective view of the apparatus for cutting the spacing adhesive tape, according to an embodiment of the present invention;

FIG. 8 is a top view of the apparatus of FIG. 7;

FIG. 9 is a lateral view of the two wheel-shaped blades included in the apparatus for dynamically illustrating operating mechanisms of the two wheel-shaped blades;

FIG. 10 is another lateral view of the two wheel-shaped blades included in the apparatus for dynamically illustrating operating mechanisms of the two wheel-shaped blades;

FIG. 11 is a top view of the apparatus for illustrating directions of forces generated when the spacing adhesive tape is cut by the two wheel-shaped blades;

FIG. 12 is a perspective view of a blade-driving unit.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

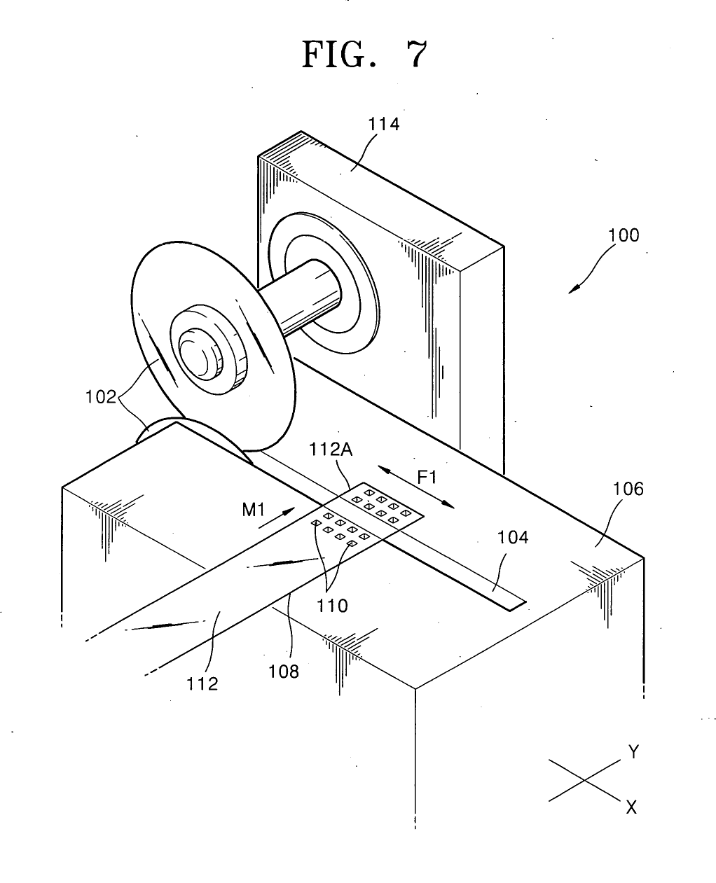

FIG. 6 is a lateral view of a pair of wheel-shaped blades 102A and 102B for illustrating a method of cutting spacing adhesive tape according to the present invention. To begin, a spacing adhesive tape 112 is prepared. The spacing adhesive tape 112 is fixed to a worktable 106 of FIG. 7 included in an apparatus 100 for cutting the spacing adhesive tape, and is cut using the two rotating wheel-shaped blades 102A and 102B. Since a portion of the wheel-shaped blades 102A and 102B overlaps (indicated by A in FIG. 6), the spacing adhesive tape 112 can be cut in a uniform size.

In the descriptions below, the term ‘tape’ may be used to represent the spacing adhesive tape, as well as other types of tape that may be used in other embodiments of the invention. Additionally, the term ‘blades’ may be used to collectively represent the two wheel-shaped blades 102A and 102B. The term ‘blade’ may refer to either of the two blades, the context clearly noting which of the two blades, 102A or 102B, is being referred to.

The two rotating blades 102A and 102B shuttle straight in an F1 direction and rotate in F2 directions, as shown in FIG. 6. In other words, the upper blade 102A rotates in a clockwise direction and the lower blade 102B rotates in a counter-clockwise direction, to cut the tape 112. The rotating blades 102A and 102B cut the tape 112 by moving forward in the direction indicated by F1 and cut the tape 112 again by moving backward to their original position in the direction indicated by F1. Therefore, the number of units into which the tape 112 is cut per hour can be increased.

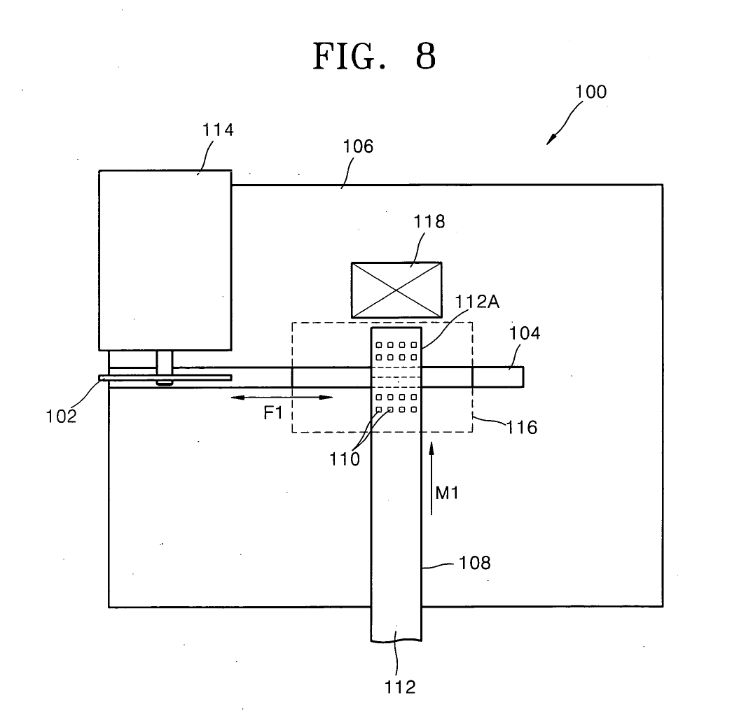

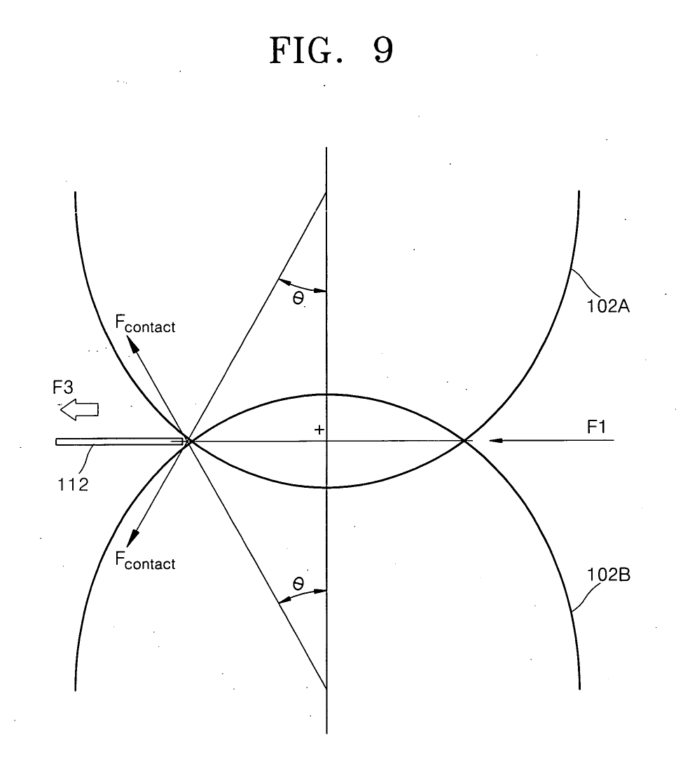

FIG. 7 is a perspective view of the apparatus 100 for cutting the tape 112. FIG. 8 is a top view of the same apparatus 100. Referring to FIGS. 7 and 8, the apparatus 100 includes a body having the worktable 106. The body includes a controller (not shown) to control the entire operation of the apparatus 100 and various driving devices controlled by the controller, such as a motor needed to drive the apparatus 100, a stepping motor, and a vacuum device.

In addition, the apparatus 100 includes a tape-moving unit 108 that may continuously move or hold the tape 112 in a Y-axis direction on the worktable 106. The apparatus 100 further includes a blade recess 104 which is a slot or groove in the worktable 106 in an X-axis direction substantially perpendicular to the tape-moving unit 108.

The apparatus 100 also includes the two blades 102A and 102B. These blades cut the tape 112 by rotating in the blade recess 104 in the X-axis direction. The blades 102A and 102B are connected to a blade-driving unit 114 driven by a motor.

The apparatus 100 may further include vacuum holes 110, which fix the tape 112 to a top surface of the worktable 106 so the blades 102A and 102B can firmly cut the tape 112. The tape-moving unit 108, which traverses the blade recess 104, may further include a picker 118, shown in of FIG. 8. The picker 118 may move tape section 112A which are pieces of tape 112 that have been cut. The apparatus 100 may further include, in a lower part of the blade recess 104, a dust remover, for example, a vacuum device 116, shown in FIG. 8, for processing dust produced when cutting the tape 112.

The tape 112 may encompass many types of tape used in semiconductor device-packaging processes. For example, the tape 112 may be formed of polyimide used in the QDP manufacturing process and may include adhesive layers formed on both sides of the polyimide.

The process of cutting the tape 112 to a uniform size will now be described in detail. The tape-moving unit 108 moves in an M1 direction and then is fixed by the vacuum holes 110 connected to a vacuum, such as the vacuum device 116 of FIG. 8. The two rotating blades 102A and 102B move in the F1 direction in the blade recess 104 that is perpendicular to the fixed tape 112 to cut the tape 112.

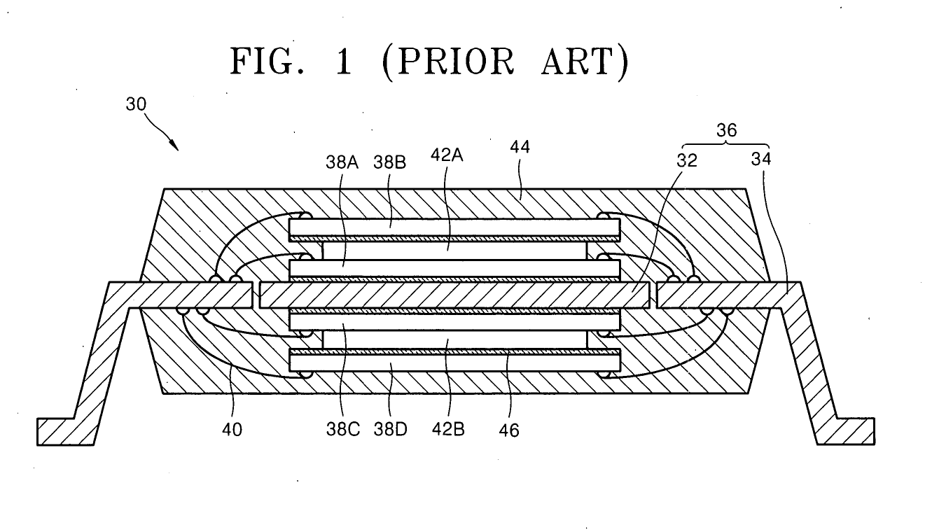

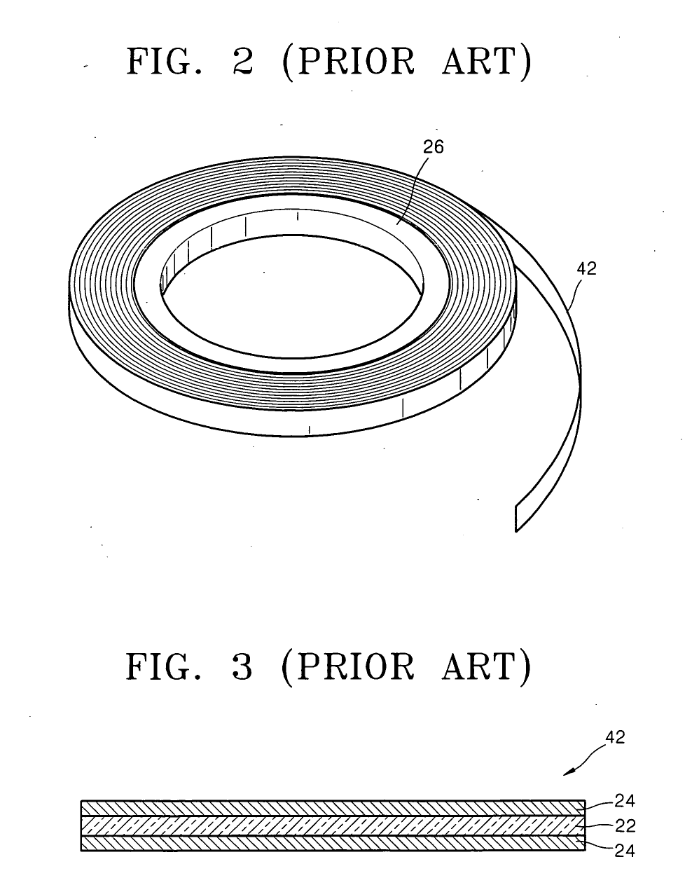

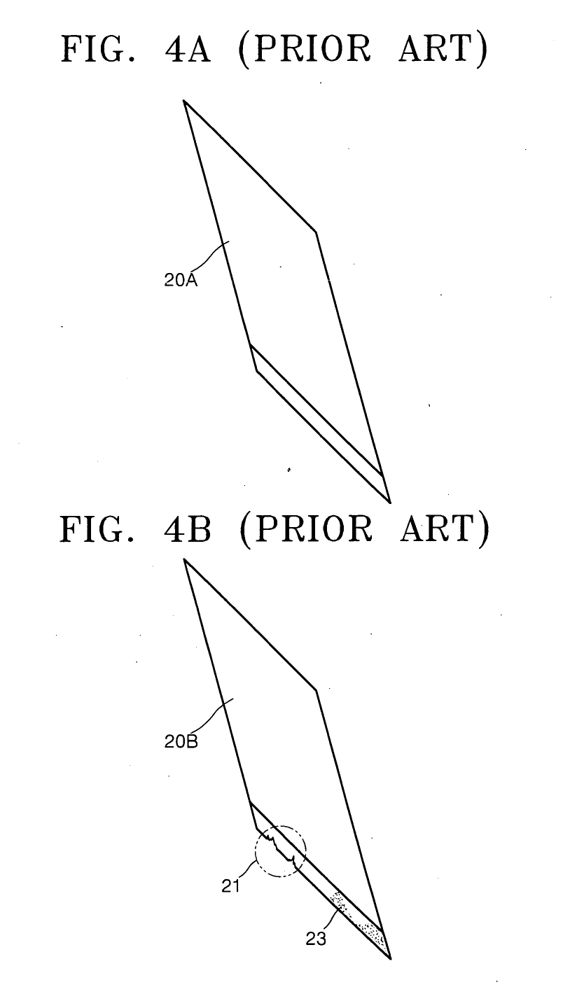

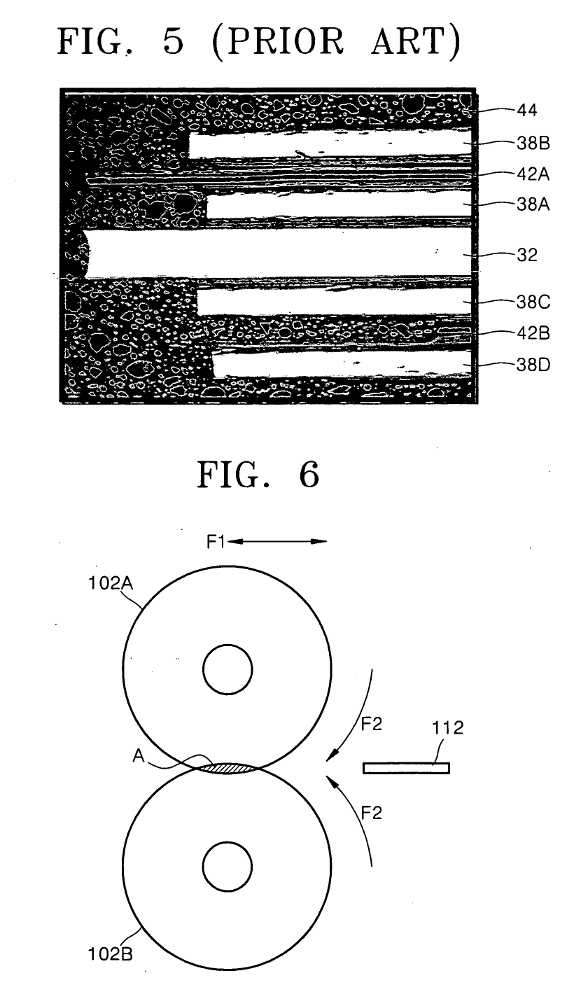

Consequently, the tape section 112A, into which the tape 112 is cut, is produced in an upper part of the tape-moving unit 108. The tape section 112A may be moved by the picker 118 to be stored or to later be used to assemble a QDP, such as that shown in FIG. 1.

Repeating the above process, the tape 112 is again moved in the M1 direction and fixed by the vacuum holes 110. Then the two rotating blades 102 again move in the F1 direction, cut the tape 112, and return to their original positions. In this process, the rotating blades 102 cut the tape 112 fixed by the vacuum-sucking holes 110 again to produce another tape section 112A, which is preferably identical to the last cut tape section 112A. The tape section 112A is again moved by the picker 18. Hereinafter, the process of cutting the tape 112 is repeated.

Dust generated in the process of cutting the tape 112 may be collected and removed by the dust remover, for example, the vacuum-sucking device 116, through the blade recess 104.

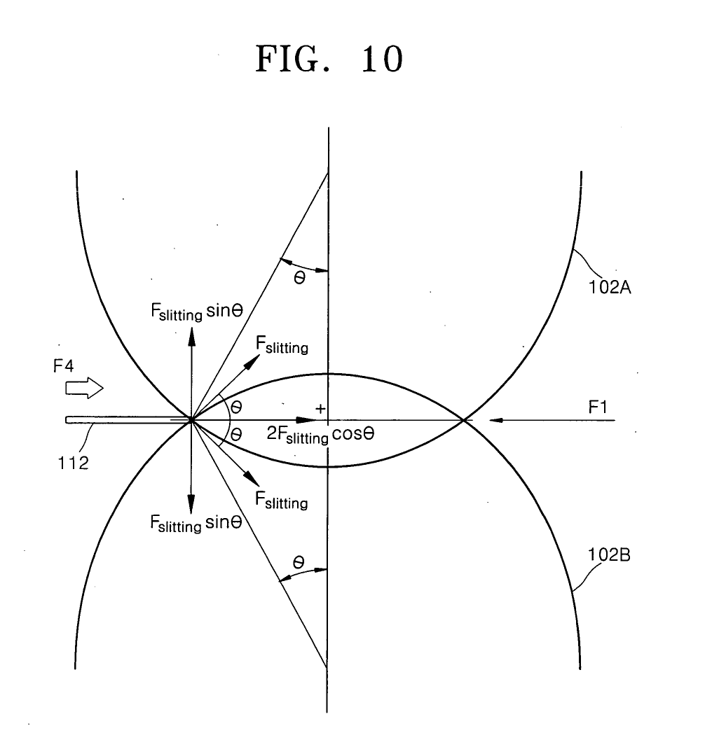

FIG. 9 is a lateral view of the two blades 102A and 102B included in the apparatus 100. If the two blades 102A and 102B move in the F1 direction without rotating to cut the tape 112, a force F_{contact} is applied to the two wheel-shaped blades 102A and 102B in a direction perpendicular to the two wheel shaped blades 102A and 102B. In addition, a force F3, i.e., F_{contact}*cos θ, is applied in a direction indicated by F3, which is a direction in which the tape 112 is cut.

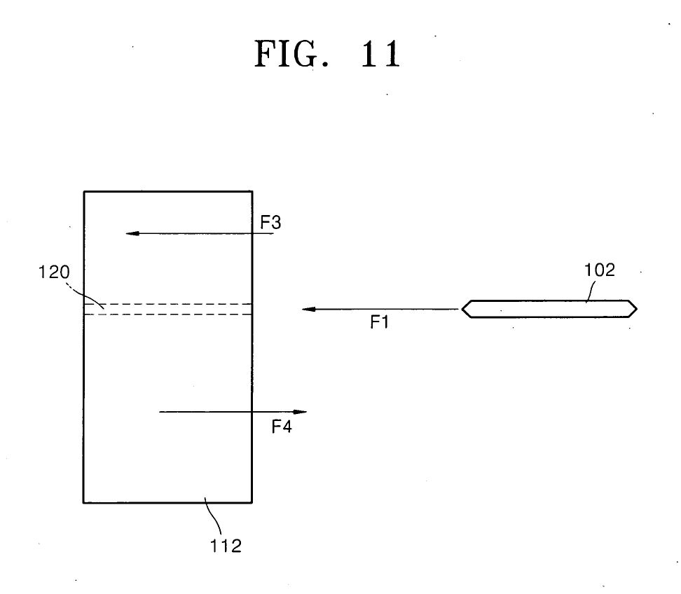

FIG. 10 is another lateral view of the two blades 102A and 102B. A force produced by the two blades 102A and 102B while moving forward in the F1 direction and rotating will now be considered.

The moment when the two blades 102A and 102B contact the tape 112 while rotating, a force F_{slitting} is applied to the two blades 102A and 102B due to speed components of the two rotating blades 102A and 102B. The force F_{slitting} may be decomposed into a force F_{slitting}*sin θ, which works in the direction that the tape 112 is cut, and F_{slitting}*cos θ, which acts in a direction opposite to the F1 direction.

A force F4, which is the sum of F_{slitting}*cos θ of both blades, acts in a direction that the tape 112 is not pushed even though the two blades 102A and 102B proceed toward the tape 112, thereby offsetting the force F3 illustrated in FIG. 9. Accordingly, the position of the tape 112 is stably fixed.

FIG. 11 is a top view of the apparatus 100 for illustrating directions of forces generated when the tape 112 is cut by the two blades 102A and 102B. Referring to FIG. 11, when the blades 102 move in the F1 direction to cut a portion 120 of the tape 112, the force F3 is applied to the tape 112 at the speed of the two blades 102. The force F3 causes the fixed position of the tape 112 to be unstable. Consequently, it is difficult to cut the tape 112 straight. Furthermore, the tape 112 may be pushed, creating a burr on its surface. The tape 112 may even break.

Hence, to solve such problems, the force F4 that works in the direction opposite to the force F3 is required. Thus, the apparatus 100 can stably cut the tape 112 in a uniform size since the force F3 is offset by the force F4. The forces F3 and F4 are originally generated by the blade-driving unit 114 of FIG. 7 connected to the two blades 102A and 102B, as well as reaction forces resulting from the rotation of the blades.

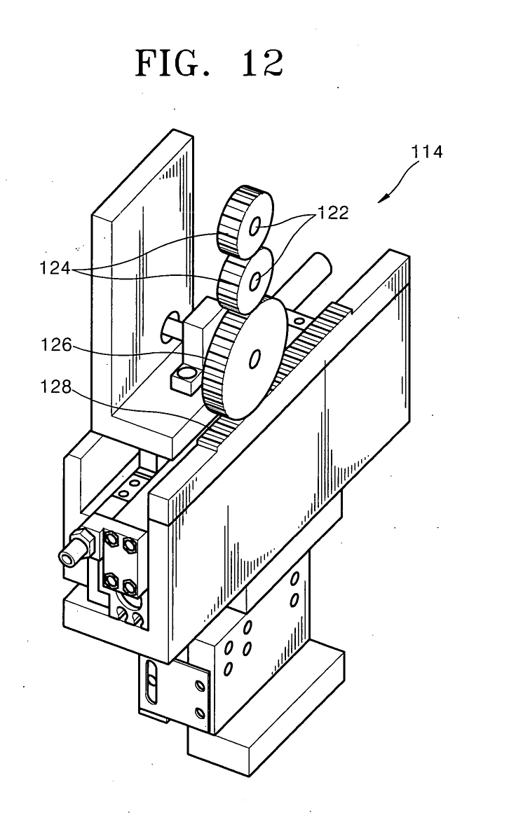

FIG. 12 is a perspective view of an embodiment of the blade-driving unit 114. Referring to FIG. 12, the two blades rotate while being fixed into a driving axis. The driving axis rotates by being fixed into axes of two spurs 122 in the blade-driving unit 114. In this case, the rotation speed of the blades 102A and 102B can be controlled by adjusting a gear ratio of a pinion 126 and the spurs 124. The speed of a motor within the blade-driving unit may also be adjusted, of course.

In addition, a rotational movement of a rack gear 128 is converted into a straight-line movement, thereby enabling the two blades 102A and 102B to move straight at constant speed. Therefore, the rotation speed (F2 of FIG. 6) and the straight-line speed (F1 of FIG. 6) of the two blades 102A and 102B can be controlled by adjusting the gear ratio of the spurs 124, the pinion 126, and the rack gear 128 included in the blade-driving unit 114.

The present invention described above has the following advantages. First, when tape is cut using a pair of rotating wheel-shaped blades, the entire edge of each blade cuts the tape to a uniform size. This is in contrast to cutting with just a portion of a fixed blade. Thus, the lifespan of the blades can be extended. Accordingly, the time required to replace blades can be reduced, thereby enhancing operating efficiency of the cutting apparatus. If it is assumed that a conventional blade can be used up to 2000 times, then the rotating blades, according to embodiments of the present invention, can be used up to approximately 3,000,000 times, which is about 1500 times longer than the conventional blade.

Second, a method of cutting tape according to embodiments of the present invention solves the problems of the tape being pushed back and forth or not being cut straight. Thus, the yield and quality of a resulting semiconductor package can be enhanced. When conventional blades are compared with the blades of the present invention in terms of straightness of a cut lane, a slit cut by conventional blades is, perhaps, 65 μm in width, while a slit cut by the blades of an embodiment of the present invention is, perhaps, 20 μm in width. Thus, the blades of embodiments of the present invention secure stable straightness by more than about three times compared with the convention blade.

Third, it may take the conventional blade perhaps 1.9 seconds to cut tape once while it may take the two wheel-shaped blades of an embodiment of the present invention perhaps 0.8 seconds. Since the two blades according to an embodiment of the present invention cut the tape in both directions while shuttling in a straight line, the two blades may have productivity more than double the productivity of the conventional blade.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for cutting a tape, the apparatus comprising:
a worktable;
a tape-moving unit to move the tape in a Y-axis direction on the worktable;
a blade recess in the worktable aligned in an X-axis direction substantially perpendicular to the tape-moving unit;
a pair of blades to cut the tape by rotating and moving in the X-axis direction in the blade recess; and
a fixing unit to fix the tape before the blades cut the tape.

2. The apparatus of claim 1, wherein the tape comprises a polyimide substrate.

3. The apparatus of claim 2, wherein the tape further comprises adhesive layers formed on both sides of the polyimide substrate.

4. The apparatus of claim 1, wherein the blades overlap with each other while they cut the tape.

5. The apparatus of claim 1, wherein the fixing unit comprises vacuum holes formed on a lower part of the tape-moving unit.

6. The apparatus of claim 1, wherein the blades cut the tape as they move forward in the blade recess, and cut a different portion of the tape by moving backward in the blade recess.

7. The apparatus of claim 1, wherein the apparatus further comprises a picker to move a cut portion of the tape.

8. The apparatus of claim 1, wherein the apparatus further comprises a dust remover to remove dust produced while cutting the tape.

9. The apparatus of claim 8, wherein the dust remover removes dust through the blade recess by a vacuum device.

10. The apparatus of claim 1, wherein the tape is a spacing adhesive tape to be used in a semiconductor.

11. A method of cutting tape, the method comprising:
placing the tape in a position to be cut;
fixing the tape in the position to a worktable; and
cutting the tape using a pair of wheel-shaped blades.

12. The method of claim 11, wherein the tape comprises a polyimide substrate.

13. The method of claim 12, wherein the tape further comprises adhesive layers formed on both sides of the polyimide substrate.

14. The method of claim 11, wherein fixing the tape includes fixing the tape to the worktable by vacuum holes formed on a top surface of the worktable.

15. The method of claim 11, wherein cutting the tape includes cutting the tape using a force generated by the blades moving in a straight line and a force generated by the blades rotating.

16. The method of claim 11, further comprising removing dust produced by cutting the tape.

17. The method of claim 15, wherein an upper blade of the blades rotates in a clockwise direction and a lower blade of the blades rotates in a counter-clockwise direction.

18. The method of claim 15, wherein the force generated by the blades moving in the straight line and the force generated by the blades rotating are offset based on a point where the tape is cut.

19. An apparatus for cutting a tape, the apparatus comprising:
two circular blades configured to rotate in opposite directions, wherein the two circular blades partially overlap each other, and wherein the two circular blades are slideably attached to a work table;
a blade recess in the work table to accommodate a sliding motion of the two circular blades; and
a tape moving unit to place a section of tape across the blade recess.

20. The apparatus of claim 19, further comprising a fixing unit to fix the tape stably in a position across the blade recess.

21. The apparatus of claim 19, wherein the two circular blades cut the tape as they move forward in the blade recess, and cut a different portion of the tape by moving backward in the blade recess.
